(19) United States
(12) Patent Application Publication
(10) Pub. No.: US 2017/0045860 A1
(43) Pub. Date: Feb. 16, 2017

(54) Dual Time Watch and Watch Case Assembly

(71) Applicant: Kwong Yau Kwok, Hong Kong (HK)

(72) Inventor: Kwong Yau Kwok, Hong Kong (HK)

(21) Appl. No.: 15/015,162

(22) Filed: Feb. 4, 2016

(30) Foreign Application Priority Data
Aug. 14, 2015 (CN) 201510502183.1

(51) Int. Cl. G04B 19/28; G04B 19/06; G04B 37/12

(52) U.S. Cl. CPC G04B 19/283; G04B 37/12; G04B 19/06

(57) ABSTRACT

The present application discloses a watch case assembly displaying two time zones as well as a watch. The watch case assembly comprises a watch case, a dial and a bezel. The dial is disposed inside the dial cavity of the watch case and intended to display the time of the first time zone. The bezel is disposed on the watch case and around the dial and intended to display the time of the second time zone. The bezel cavity of the watch case has at least one fixing part, the bezel has at least two installation parts fixed to the fixing parts in a detachable manner, the assembly structure of the fixing parts and the installation parts is detachable, at least two installation parts on the bezel may be fixed to the fixing parts respectively.

### CROSS-REFERENCE TO RELATED APPLICATION

This present application claims the benefit of Chinese Patent Application No. 201510502183.1 filed on Aug. 14, 2015, the contents of which are hereby incorporated by reference.

### TECHNICAL FIELD

The present application relates to a watch, particularly to a dual time watch.

### DESCRIPTION OF THE RELATED ART

Watch, also known as wrist watch, is an instrument worn on a wrist and used to keep and display time. With the progress of the society and the development of globalization, people are extending their range of activities. It is a common that people from different countries in different time zones contact each other. The time indications of different time zones are exerting increasing influence on the people. Under this circumstance, it would be rather inconvenient if users have to adjust the time displayed on the dial to the time of the current time zone every time.

For this reason, a watch which can display two time zones in the same time emerged, gaining favor from numerous users. However, the current dual time watches usually need a complex mechanism to adjust the time in the two time zones. For example, two movements are used to show two time zones.

### SUMMARY OF THE INVENTION

The present application provides a new-type watch case assembly, which can display two time zones, as well as a watch adopting the watch case assembly.

The watch case assembly displaying two time zones as provided by the present application comprises: a watch case, having a dial cavity and a bezel cavity around the dial cavity; a dial, intended to display the time of the first time zone and disposed inside the dial cavity in a fixed manner; and a bezel, intended to display the time of the second time zone and disposed inside the bezel cavity in a detachable manner, wherein the bezel cavity has at least one fixing part and the bezel has at least two installation parts arranged in different positions and fixed to the fixing part in a detachable manner.

As further improvement to the watch case assembly, there are 12 installation parts and 12 fixing parts.

As further improvement to the watch case assembly, the bezel is provided with a force applying part through which force may be applied during disassembly of the bezel.

As further improvement to the watch case assembly, the force applying part is a notch and/or a convex buckle on the bezel.

As further improvement to the watch case assembly, the fixing parts are grooves on the wall of the bezel cavity, and the installation parts are bulges matched with the grooves.

As further improvement to the watch case assembly, the fixing part includes at least two grooves, the at least two grooves include an inner groove and an outer groove opposite to the inner groove, the installation part includes at least two bulges, the at least two bulges include an inner bulge and an outer bulge corresponding to the inner bulge, the inner bulge is matched with the inner groove, and the outer bulge is matched with the outer groove.

As further improvement to the watch case assembly, the fixing parts are bulges on the wall of the bezel cavity, and the installation parts are grooves matched with the bulges.

As further improvement to the watch case assembly, the installation part includes at least two grooves, the at least two grooves include an inner groove and an outer groove opposite to the inner groove, the fixing part includes at least two bulges, the at least two bulges include an inner bulge and an outer bulge corresponding to the inner bulge, the inner bulge is matched with the inner groove, and the outer bulge is matched with the outer groove.

The dual time watch provided by the present application comprises a movement, a pointer and any watch case assembly as recited above. The movement is disposed inside the watch case of the watch case assembly, and the pointer is on the dial.

The beneficial effect of the present application: the watch case assembly provided by the present application comprises a watch case, a dial and a bezel. The dial is disposed inside the dial cavity of the watch case and intended to display the time of the first time zone. The bezel is disposed on the watch case and around the dial and intended to display the time of the second time zone. The bezel cavity has at least one fixing part. The bezel has at least two installation parts fixed to the fixing part in a detachable manner. The user may fix the installation parts to the fixing parts so as to fix the bezel onto the watch case. Each of the dial and the bezel may provide display of one time zone, thereby realizing display of two time zones. The assembly structure of the fixing parts and the installation parts is detachable. On the bezel, at least two installation parts may be fixed to the fixing parts respectively, thereby assuring the bezel may provide display of at least two time zones. During switching, the user only needs to remove the bezel and reinstall it. This approach may simplify the structure of the watch case and bezel and reduce manufacturing cost.

### BRIEF DESCRIPTION OF THE DRAWINGS

FIG. 1 is a schematic of the watch head in an embodiment of the dual time watch provided by the present application;

FIG. 2 is a schematic of the repositioned bezel in the structure shown in FIG. 1;

FIG. 3 is a schematic of an embodiment of the watch case provided by the present application;

FIG. 4 is a cross section along A-A line in FIG. 3;

FIG. 5 is a schematic of an embodiment of the bezel provided by the present application;

FIG. 6 is a cross section along B-B line in FIG. 5.

### DETAILED DESCRIPTION OF PREFERRED EMBODIMENTS

Below the present invention is further described in details by referring to embodiments and accompanying drawings. The present application may be realized in various forms and is not limited to the mode of execution described in this embodiment. The purpose of providing the following embodiment is to more clearly and thoroughly understand the content disclosed by the present application. The words indicating directions, such as: up, down, left and right, only indicate the positions of the shown structure in the accompanying drawings.

However, those skilled in the art may know one or more details may be omitted, or other methods, assemblies or materials may be adopted. In some examples, some modes of execution are not described or not described in details.

Besides, the technical features and technical schemes recorded in this document may also be combined in one or a plurality of embodiments in any appropriate way.

### Embodiment 1

Embodiment 1 provides a watch, which may display two time zones. This watch is a pointer type watch. It may be a mechanical watch, or quartz watch, or any of other pointer type watches.

This watch comprises a watch head and a watch strap. The watch head is intended to display and adjust time. The watch strap is connected to the watch head so that the user can wear the watch.

This watch head comprises a watch case assembly, a movement, a pointer, a back cover, a time-adjusting crown and a transparent surface.

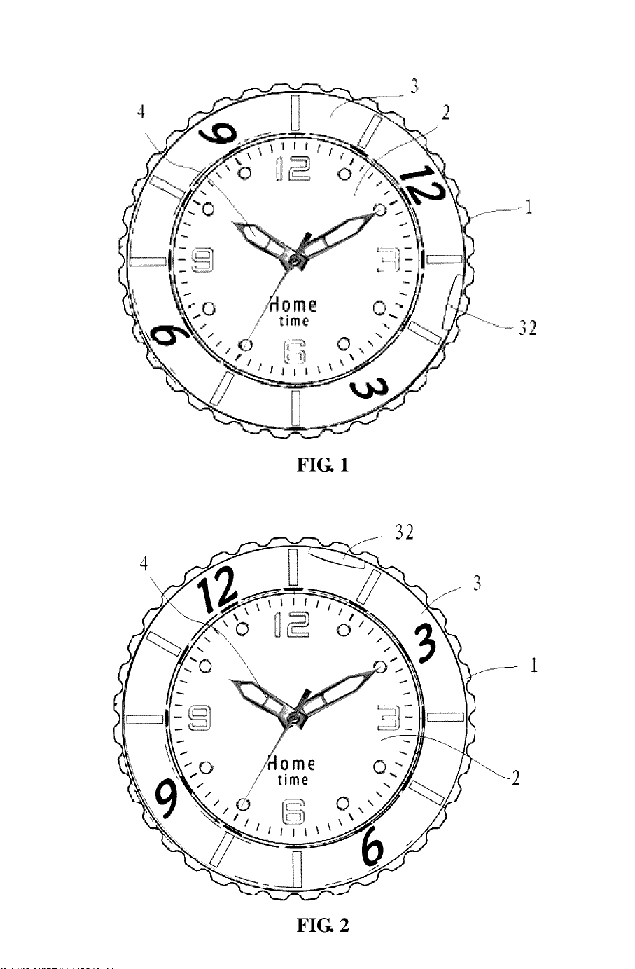

Please refer to FIG. 1 and FIG. 2. This embodiment shows a watch case assembly, comprising a watch case 1, a dial 2 and a bezel 3. This embodiment also shows a pointer 4, on the dial 2.

Other components, such as: movement, back cover, transparent face and crown, are not the improvement emphases of the present application and are omitted here. The movement is disposed inside the watch case 1. The back cover is disposed rear the watch case 1.

Please refer to FIG. 1 to FIG. 3. The dial 2 is intended to display the time of the first time zone in form of Arabic numerals, Roman numerals, Chinese word figures or any other markings which can express time. The dial 2 is disposed inside the dial cavity 11 in a fixed manner. After installation, the dial 2 is fixed relative to the watch case 1.

The bezel 3 is intended to display the time of the second time zone, likewise in form of Arabic numerals, Roman numerals, Chinese word figures or any other markings which can express time. The bezel 3 is disposed inside the bezel cavity 12 in a detachable manner, wherein the bezel cavity 12 has at least one fixing part, and the bezel 3 has at least two installation parts arranged in different positions and fixed to the fixing part in a detachable manner.

Each of the bezel 3 and the dial 2 may provide display of one time zone, thereby realizing display of two time zones. Further, the assembly structure of the fixing parts and installation parts is detachable. On the bezel 3, at least two installation parts may be fixed to the fixing parts respectively, thereby assuring the bezel 3 may provide display of at least two time zones. During switching, the user only needs to remove the bezel 3 and reinstall it. This approach may simplify the structure of the watch case 1 and the bezel 3 and reduce manufacturing cost.

For instance, there is one fixing part inside the bezel cavity 12, and the bezel 3 has two installation parts, which are the first installation part and the second installation part. The first installation part is fixed with the fixing part. In this case, the bezel 3 can be used to display the time of the first time zone. If the first installation part is removed and the second installation part is fixed with the fixing part, the position of the bezel 3 will be changed and the bezel 3 can be used to display the time of the second time zone.

Please refer to FIG. 1 and FIG. 2. If the time displayed in the dial 2 is Beijing Time, then at 10:10 Beijing Time, the bezel 3 in FIG. 1 displays 8:00 (or 20:00) in another time zone, and the bezel 3 in FIG. 2 displays 11:15 (23:15) in another time zone.

Of course, the purpose of describing that the bezel cavity 12 has one fixing part and the bezel 3 has two installation parts is for easy understanding. As a matter of facts, there may be at least one fixing part and at least two installation parts.

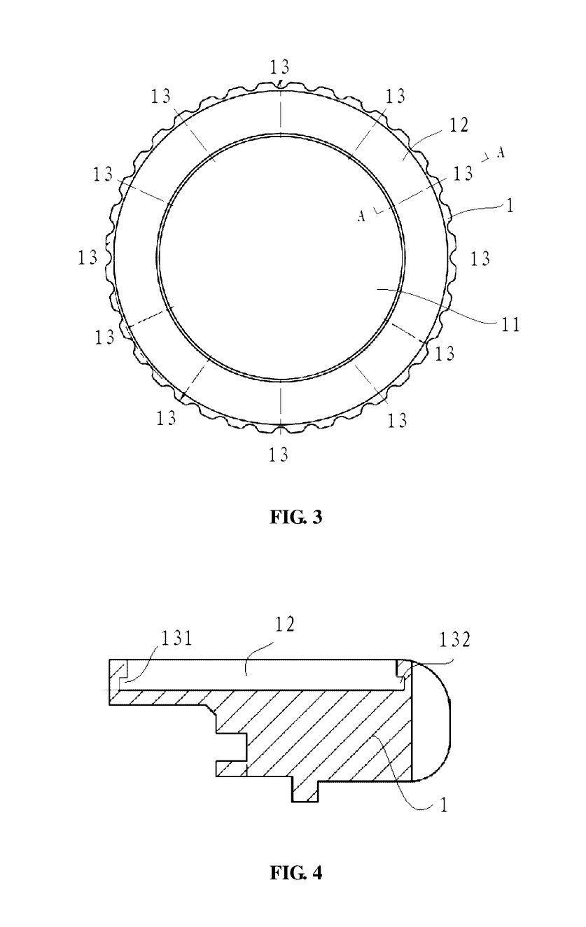

Please refer to FIG. 3. The watch case 1 has a dial cavity 11 and a bezel cavity 12 around the dial cavity 11. The dial cavity 11 is intended to receive the dial 2 and the movement. The bezel cavity 12 is intended to receive the bezel 3.

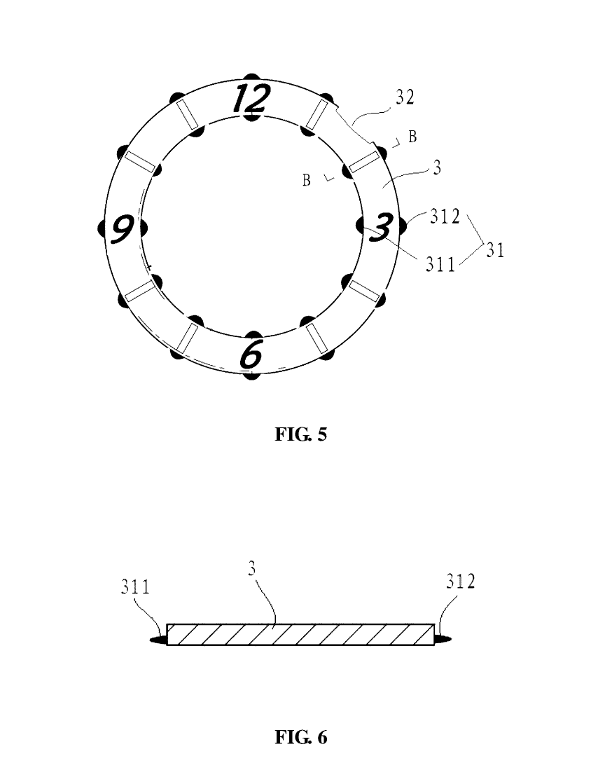

Further, in this embodiment, there are 12 installation parts and 12 fixing parts. In FIG. 3, number 13 is used to express the distribution positions of the 12 fixing parts. FIG. 5 shows the distribution positions of the 12 installation parts (FIG. 5 only exemplarily states one installation part 31). The 12 installation parts and 12 fixing parts may be freely combined to form more time zone display schemes.

Preferably, the time interval between two installation parts is one hour, the time interval between two adjacent fixing parts is one hour, too, and 12 installation parts exactly correspond to the setting of 12 hours.

This embodiment adopts the structure of 12 fixing parts and 12 installation parts, which are roughly evenly distributed on the bezel 3 and the bezel cavity 12. When the bezel 3 is installed on the bezel cavity 12, 12 fixing locations may be realized. At each fixing location, at least one fixing point may be set (in the present application, one fixing location has two fixing points at inside and outside of the bezel respectively) to assure the fixing effect between the bezel 3 and the watch case 1.

Further, the fixing part 13 may be a groove disposed on the wall of the bezel cavity 12 and the installation part 31 is a bulge matched with the groove. The fixing part and the installation part realize fixation through concave and convex matching.

Please refer to FIG. 3 and FIG. 4. One fixing part includes at least two grooves, the at least two grooves include an inner groove 131 and an outer groove 132 opposite to the inner groove 131. Here it is supposed that one fixing part consists of one inner groove 131 and one outer groove 132.

Please refer to FIG. 5 and FIG. 6. One installation part includes at least two bulges, the at least two bulges include an inner bulge 311 and an outer bulge 312 corresponding to the inner bulge 311, the inner bulge 311 is matched with the inner groove 131, and the outer bulge 312 is matched with the outer groove 132. Here it is supposed that one installation part consists of one inner bulge 311 and one outer bulge 312.

During assembly of the bezel 3, the installation of the bezel 3 may be completed by snapping the inner bulge 311 on the installation part 31 into the inner groove 131 of corresponding fixing part 13 and snapping the outer bulge 312 into the outer groove 132 of corresponding fixing part 13. This installation method is very convenient and the structure is simple.

Of course, in other embodiments, the fixing parts 13 may also be bulges disposed on the wall of the bezel cavity 12, and the installation parts 31 are grooves matched with bulges.

Likewise, one installation part also includes at least two grooves and the at least two grooves include an inner groove and an outer groove opposite to the inner groove. One fixing part includes at least two bulges, the at least two bulges include an inner bulge and an outer bulge corresponding to the inner bulge. The inner bulge is matched with the inner groove, and the outer bulge is matched with the outer groove.

Further, in order that the bezel 3 can be more conveniently installed inside the bezel cavity 12, the installation parts 31 and/or the fixing parts 13 are made of elastic material. For example, except the installation parts 31, the bezel 3 can be made of glass fiber or other hard materials, while the installation parts 31 are made of rubber, plastic or other elastic materials; or the bezel may be made of elastic material as a whole.

If the time zone needs to be changed, the bezel 3 can be taken out, and the corresponding installation part 31 is installed on the fixing part 13 according to the needed time zone.

Further, the bezel 3 is provided with force applying part, which plays an assistant role during removal of the bezel 3. The force applying part can conveniently provide a force applying point when the user removes the bezel 3.

Please refer to FIG. 1, FIG. 2 and FIG. 5, this force applying part may be a notch 32 on the bezel 3. This notch 32 helps the user insert his finger to dig out the bezel 3.

Or, in other embodiments, this force applying part may also be a convex buckle on the bezel 3. This convex buckle helps the user to dig out the bezel 3 by finger.

In the structure of the watch case assembly shown in this embodiment, the bezel structure is simple and economical and has low manufacturing cost. Moreover, it can easily change time zones and realize the function of displaying two time zones.

The present invention is further described in details above by referring to preferred embodiments, but it shall not be deemed that the implementation of the present invention is limited to these descriptions. Those skilled in the art may make simple deductions or substitutions under the precondition of not departing from the spirit of the present invention.

1. A watch case assembly displaying two time zones, wherein it comprises:
a watch case, having a dial cavity and a bezel cavity around the dial cavity;
a dial, intended to display time of the first time zone and disposed inside the dial cavity in a fixed manner; and
a bezel, intended to display time of the second time zone and disposed inside the bezel cavity in a detachable manner, wherein the bezel cavity has at least one fixing part and the bezel has at least two installation parts arranged in different positions and fixed to the fixing part in a detachable manner;
and wherein the bezel is provided with a force applying part through which force may be applied during disassembly of the bezel.

2. The watch case assembly according to claim 1, wherein there are twelve installation parts and twelve fixing parts.

3. The watch case assembly according to claim 1, wherein the installation parts and/or fixing part are made of elastic material.

4. (canceled)

5. The watch case assembly according to claim 1, wherein the force applying part is a notch and/or a convex buckle disposed on the bezel.

6. The watch case assembly according to claim 1, wherein the fixing part is a groove disposed on the wall of the bezel cavity, and the installation parts are bulges matched with the groove.

7. The watch case assembly according to claim 6, wherein the fixing part includes at least two grooves, each of the at least two grooves include an inner groove and an outer groove opposite to the inner groove, the installation part includes at least two bulges, the at least two bulges include an inner bulge and an outer bulge corresponding to the inner bulge, the inner bulge is matched with the inner groove, and the outer bulge is matched with the outer groove.

8. The watch case assembly according to claim 1, wherein the fixing part is a bugle disposed on the wall of the bezel cavity, and the installation parts are the grooves matched with the bulge.

9. The watch case assembly according to claim 8, wherein each of the installation part includes at least two grooves, the at least two grooves include an inner groove and an outer groove opposite to the inner groove, the fixing part includes at least two bulges, the at least two bulges include an inner bulge and an outer bulge corresponding to the inner bulge, the inner bulge is matched with the inner groove, and the outer bulge is matched with the outer groove.

10. A dual time watch, comprising a movement and a pointer, wherein the watch also comprises a watch case assembly, the movement is disposed inside the watch case of the watch case assembly and the pointer is on the dial
and wherein the watch case assembly comprises:
a watch case, having a dial cavity and a bezel cavity around the dial cavity;
a dial, intended to display time of the first time zone and disposed inside the dial cavity in a fixed manner; and
a bezel, intended to display time of the second time zone and disposed inside the bezel cavity in a detachable manner, wherein the bezel cavity has at least one fixing part and the bezel has at least two installation parts arranged in different positions and fixed to the fixing part in a detachable manner;
and wherein the bezel is provided with a force applying part through which force may be applied during disassembly of the bezel.

11. The dual time watch according to claim 10, wherein the bezel cavity has twelve fixing parts and the bezel has twelve installation parts arranged in different positions and fixed to the fixing parts in a detachable manner.

12. The dual time watch according to claim 10, wherein the installation parts and/or fixing part are made of elastic material.

13. (canceled)

14. The dual time watch according to claim 10, wherein the force applying part is a notch and/or a convex buckle disposed on the bezel.

15. The dual time watch according to claim 10, wherein the fixing part is a groove disposed on the wall of the bezel cavity, and the installation parts are bulges matched with the groove.

16. The dual time watch according to claim 15, wherein the fixing part includes at least two grooves, each of the at least two grooves include an inner groove and an outer groove opposite to the inner groove, the installation part includes at least two bulges, the at least two bulges include an inner bulge and an outer bulge corresponding to the inner bulge, the inner bulge is matched with the inner groove, and the outer bulge is matched with the outer groove.

17. The dual time watch according to claim 10, wherein the fixing part is a bugle disposed on the wall of the bezel cavity, and the installation parts are the grooves matched with the bulge.

18. The dual time watch according to claim 17, wherein each of the installation part includes at least two grooves, the at least two grooves include an inner groove and an outer groove opposite to the inner groove, the fixing part includes at least two bulges, the at least two bulges include an inner bulge and an outer bulge corresponding to the inner bulge, the inner bulge is matched with the inner groove, and the outer bulge is matched with the outer groove.
